(19) United States
(12) Patent Application Publication
(10) Pub. No.: US 2007/0058664 A1
(43) Pub. Date: Mar. 15, 2007

(54) Method and Apparatus for Lifetime Maximization of Wireless Sensor Networks

(75) Inventors: Seung-Jun Kim, Plainsboro, NJ (US); Xiaodong Wang, New York, NY (US); Mohammad Madihian, Plainsboro, NJ (US)

Correspondence Address: NEC LABORATORIES AMERICA, INC., 4 INDEPENDENCE WAY, PRINCETON, NJ, 08540, US

(73) Assignee: NEC LABORATORIES AMERICA, INC., Princeton, NJ (US)

(21) Appl. No.: 11/277,179

(22) Filed: Mar. 22, 2006

Related U.S. Application Data
(60) Provisional application No. 60/717,211, filed on Sep. 15, 2005.

(51) Int. Cl. H04L 12/413; H04L 12/43

(52) U.S. Cl. 370/447; 370/458

(57) ABSTRACT

A method and apparatus for distributed routing at the network layer of a network is disclosed that integrates contention resolution properties from the MAC layer. In one embodiment, an energy constraint is used in routing at the network layer of a network to determine a first parameter representing the optimal maximum lifetime of a sensor network. If a network link for a transmission is idle, the node may then contend at the MAC layer of the network for a transmission slot across that link. During this contention period, each node is assigned a penalty parameter that is used to represent the probability of a transmission colliding with another transmission across a link in a contention region. As a result of this contention period, network traffic is transmitted from sensor nodes.

This application claims the benefit of U.S. Provisional Application No. 60/717,211, filed Sep. 15, 2005, which is hereby incorporated herein by reference.

### BACKGROUND OF THE INVENTION

The present invention relates generally to medium access control in communication networks.

Sensor networks are used in many different applications such as, for example, habitat monitoring, location tracking and inventory management. Such networks are typically characterized by hundreds or thousands of individual sensors located at sensor nodes distributed over a desired area. The sensors in a sensor network are typically able to communicate, for example via wired or wireless communications methods, to other sensors and one or more monitoring nodes in the network. A monitoring node is a node that collects and processes data received from the sensor nodes and is, typically more robust than a sensor node. Each sensor is able to detect at least one characteristic of its surroundings by obtaining appropriate measurements, such as acoustic, temperature, seismic, or other measurements, and may be able to perform simple computations related to those measurements. Then, at a predetermined schedule or in response to an ad hoc request from, for example, a monitoring node, the sensor transmits those measurements and computations to other nodes in the network, such as to the aforementioned monitoring node.

Sensor networks face significant energy constraints because, typically, sensors are spread over a wide area and are unattended. Accordingly, replacing batteries on the sensors may be cost and time prohibitive or even impossible. While such sensors have gained significantly in processing abilities, the amount of energy stored in sensor batteries has not gained to such an extent. Therefore, many advanced techniques for routing, communications, signal processing and hardware design have been used to help reduce the required transmit power and, hence, increase the life of batteries.

Some prior attempts to minimize energy consumption in sensor networks focused on selecting routing paths through a network such that packets were delivered using routes that required the lowest amount of energy. However, these attempts typically did not take into account the fact that sensor nodes at different locations in the network experienced significantly different energy consumption rates. For example, since the nodes in a sensor network are typically arranged in a tree-like network, nodes closest to the monitoring node (also referred to herein as the “sink” node) will be required to transmit more traffic than, for example, a node at the end of a branch of the network tree and will, therefore, experience the greatest energy consumption. Accordingly, other attempts at improving routing in sensor networks focused on maximizing the lifetime of the overall network. As used herein, the lifetime period of a network is defined as being the period of time ending when any node in the network depletes its available energy and, thus, cannot operate any longer. Therefore, routing decisions in these attempts were made to maximize the time before the first occurrence of energy depletion at any node in the network.

Various attempts at lifetime maximization of a network have been made. For example, some attempts relied on only the network layer and routing decisions made in that layer to maximize the life of a network. However, these attempts ignored constraints that were placed on the network at, for example, the medium access control (MAC) layer and/or the physical (PHY) layer of the network. This is undesirable as the operation of these layers of the network can greatly impact energy consumption of the nodes in the network. Therefore, other attempts used a cross-layer method, taking into account operations at the MAC and PHY layers jointly. However, due to the complexity of the routing decisions and computations required for such a cross-layer routing method, these attempts typically relied on centralized control of routing decisions. Such centralized control increased the data traffic overhead due to increased message traffic between various sensor nodes and a central control node and, thus, disadvantageously increased energy consumption throughout the network.

### SUMMARY OF THE INVENTION

The present invention substantially solves the foregoing problems. In accordance with the principles of the present invention, a distributed routing algorithm at the network layer integrates contention resolution properties from the MAC layer. In one embodiment, an energy constraint is used in a routing algorithm at the network layer of a network to determine a first parameter representing the optimal maximum lifetime of a sensor node. If the transmission medium around a network link is idle, the node may then contend at the MAC layer of the network for a transmission slot across that link. During this contention period, each node is assigned a penalty parameter that is used to represent the probability of a transmission colliding with another transmission across a link in a contention region. According to the results of this contention, network traffic is transmitted from sensor nodes. Advantageously, the network routing algorithm only requires locally-obtainable variables and, therefore, no central control of routing in the network is required.

The network routing technique disclosed herein, when utilized in conjunction with medium access control techniques in accordance with the principles of the present invention, advantageously maximizes the lifetime of the network. These and other advantages of the invention will be apparent to those of ordinary skill in the art by reference to the following detailed description and the accompanying drawings.

### BRIEF DESCRIPTION OF DRAWINGS

FIG. 1 is a diagram illustrating a wireless communication network, suitable for implementation of an embodiment of the present invention;

FIG. 2 illustrates the slot structure of a medium access control method, in accordance with an embodiment of the invention;

FIG. 3 shows a flow contention graph in accordance with an embodiment of the present invention;

FIG. 4 is pseudo-code illustrating a joint routing and medium access control algorithm in accordance with one embodiment of the present invention; and

FIG. 5 shows an illustrative sensor node in accordance with another embodiment of the present invention.

### DETAILED DESCRIPTION OF THE INVENTION

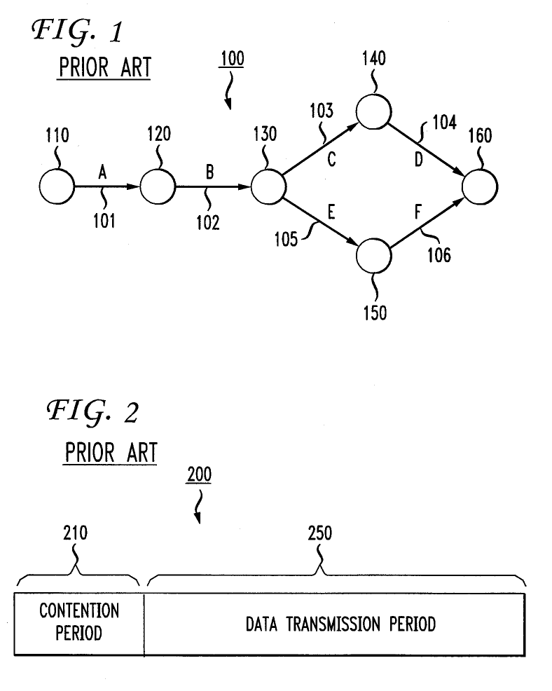

FIG. 1 is a diagram illustrating a wireless communication network 100 suitable for implementation of an embodiment of the present invention. Wireless network 100 has, illustratively, a plurality of sensor nodes 110-160, each having one or more wireless antennas. Each node is, for example and without limitation, a wireless sensor, such as that discussed above, which gathers and transmits information in a distributed manner. Sensor nodes 110-160 are illustratively arranged in an ad hoc network linked together via illustrative network links 101-106, also denoted as links A-F. As is well known, an ad hoc network is a network in which nodes in the network directly discover and communicate in a peer-to-peer fashion without involving a central access point. In such a network, sensor nodes 110-160 transmit information from one sensor node to another via links 101-106 and are capable of autonomously synchronizing their activities.

FIG. 2 shows one illustrative embodiment of how sensor nodes 110-160 of FIG. 1 use medium access control to transmit data. Specifically, referring to FIG. 2, access to the wireless transmission medium is provided using transmission slots. Different transmissions to and from different sensor nodes are multiplexed onto the transmission medium using those slots. As one skilled in the art will recognize, the type of transmission slot will depend on the particular multiplexing technique utilized, e.g., the transmission slot would represent a time slot if a time division multiplexing technique is utilized. In FIG. 2, each transmission slot 200 is subdivided into a contention resolution period 210 and a data transmission period 250. During the contention resolution period 210, interfering links are resolved in order to determine the order of transmissions across links between sensor nodes. As used herein, two links mutually interfere with each other if either the transmitter or the receiver of one link is within the interference range of the transmitter or the receiver of another link. For example, in network 100, contention may arise due to interference, illustratively, between the links in the network such as between link 101 and link 103.

In addition to being within the interference range of each other, links may also be in contention with each other for other reasons. For example, one skilled in the art will recognize that various constraints may exist in a network such as the network of FIG. 1. In particular, the radios of the sensor nodes in such networks may be unable to transmit and receive at the same time. In this case, the inbound and the outbound flows to a particular sensor node might interfere with each other and, therefore, are in contention with each other. Similarly, a particular radio might be able to communicate with a single user only and, therefore, when communications are necessary between more than a single user, flows over the links to those users will be in contention. Referring once again to FIG. 1, for example, link 101 and link 102 cannot be active simultaneously because node 120 cannot receive and transmit at the same time. Also, link 104 and link 106 may be in contention with each other because, illustratively, node 160 may only be able to communicate with a single user.

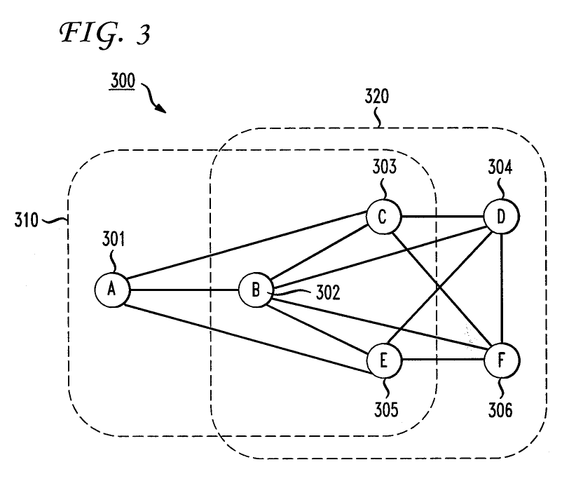

The contention relationship of the links in network 100, such as the contentions discussed above, can be captured by a flow contention graph. FIG. 3 shows such a flow contention graph 300 constructed from the network topology in FIG. 1. Referring to FIG. 3, in such a flow contention graph, the nodes, or vertices, of the graph represent active links and the edges, or connecting lines, between those nodes represent the contention relations. More particularly, graph nodes 301-306 in FIG. 3, represent links A-F of FIG. 1. For example, since link A and link F are in contention relation, the nodes 301 and 302 corresponding to links A and F must be connected by an edge in the contention graph of FIG. 3. As one skilled in the art will recognize, the construction of a flow contention graph depends on the model of the physical layer as well as the multiple access control scheme used. As one skilled in the art will also recognize, if the well-known method for carrier-sense multiple-access (CSMA) is used, the links that are in the carrier-sensing range of each other are modeled to be in contention relation in the flow contention graph 300.

From the flow contention graph 300, cliques can be identified. As used herein, a clique is defined as a sub-graph of a flow contention graph in which each pair of vertices is connected by an edge. The cliques 310 and 320 of the graph in FIG. 3 are marked by the dotted curves. Only one link in a clique can be active at a time. Thus the links in the same clique constitute what is referred to herein as a contention region. A link can be a member of more than one clique (e.g., links B, C and E represented by nodes 302, 303 and 305). In such a case, a flow across that link can succeed only if no other link in any clique to which that link belongs is active at the same time.

With the contention graph of FIG. 3 in mind, it is possible to derive a necessary condition for the MAC layer scheduling of flows across the links of the network of FIG. 1. The average flow rate over link lεL is herein denoted by xₗ, where L is the set of all links in a network. In addition, the capacity of link l provided by the physical layer is denoted by cₗ. These are predetermined constants whose values are dependent on the physical layer implementation including such variables as power, frequency bandwidth, modulation and other variables. Then the normalized flow rate xₗ/cₗ is the fraction of time needed to sustain the flow rate xₗ. Thus, a necessary condition for a feasible schedule at the MAC layer can be written as:

$${\sum }_{l ∈ {C}_{i}} \frac{{x}_{l}}{{c}_{l}} \leq 1 , i = 1 , 2 , … , {N}_{C} \qquad Equation 1$$

where Cᵢ denotes the set of links in the i-th contention region, and N_{C} is the total number of such regions. One skilled in the art will recognize that the condition in Equation 1 does not always imply that a schedule exists that achieves the flow rates xₗ. Therefore, any network lifetime solution based on Equation 1 would only represent a maximum possible lifetime, and any data transmission schedule obtained using this condition might not be actually feasible. In order to be able to accomplish MAC scheduling with a feasible and achievable lifetime measurement, the MAC constraints are approximated using the collision statistics obtained from the actual random access procedure as described herein below.

In order to include the energy and the routing requirements, consider a network of sensor nodes nεN, among which Nₛ nodes are the source nodes where information is generated at an average rate of sₙ>0. Each link lεL is considered as unidirectional with bidirectional links being represented by two unidirectional links. Accordingly, the flow conservation law of the network can be stated as:

$${\sum }_{l ∈ O ( n )} {x}_{l} - {\sum }_{l ∈ I ( n )} {x}_{l} = {s}_{n} , n ∈ N \qquad Equation 2$$

where O(n) is the set of links originating from node n, and I(n) is the set of links entering node n. The values of sₙ for the non-source nodes are set to zero, signifying that all the traffic entering such nodes must be routed. The energy consumed by transmitting a unit amount of traffic over link l may be denoted as eₗ and the energy stored initially at node n as Eₙ. Accordingly, the energy conservation constraint can be written as:

$${\sum }_{l ∈ O ( n )} {e}_{l} {x}_{l} T \leq {E}_{n} , n ∈ N \qquad Equation 3$$

where T is the lifetime of the network. One skilled in the art will recognize that, while the energy consumption associated with reception has been ignored in Equation 3, extending the formulation to include the energy consumption in reception of flows at a sensor node is straightforward.

In light of the foregoing, the lifetime maximization problem with the MAC constraints can be stated as:

$${max T}_{{x}_{l} \geq 0 , T \geq 0} \\ subject to \\ {\sum }_{l ∈ O ( n )} {x}_{l} - {\sum }_{l ∈ I ( n )} {x}_{l} = {s}_{n} , n ∈ N \\ {\sum }_{l ∈ O ( n )} {e}_{l} {x}_{l} T \leq {E}_{n} , n ∈ N \\ {\sum }_{l ∈ {C}_{i}} \frac{{x}_{l}}{{c}_{l}} \leq 1 , i = 1 , 2 , … , {N}_{C} \qquad Equation 4$$

One skilled in the art will recognize that the problem represented by Equation 4 can be transformed into a linear programming (LP) problem by replacing the variable T according to the expression q=1/T. As one skilled in the art will recognize, LP problems are optimization problems in which an objective function and the constraints applied to the function are linear. As one skilled in the art will further recognize, LP is a well known method of optimization of network flow problems. Accordingly, with the change of variable q=1/T, the problem can be stated as an LP problem:

$${min}_{{x}_{l} \geq 0 , q \geq 0} q \\ subject to \\ {\sum }_{l ∈ O ( n )} {x}_{l} - {\sum }_{l ∈ I ( n )} {x}_{l} = {s}_{n} , n ∈ N \\ {\sum }_{l ∈ O ( n )} {e}_{l} {x}_{l} \leq {qE}_{n} , n ∈ N \\ {\sum }_{l ∈ {C}_{i}} \frac{{x}_{l}}{{c}_{l}} \leq 1 , i = 1 , 2 , … , {N}_{C} \qquad Equation 5$$

One skilled in the art will recognize, however, that any algorithm for solving Equation 5 based on, for example, dual decomposition cannot be fully distributed, since a central node is required to collect information such as Lagrange multipliers associated with energy conservation constraints at the sensor nodes globally across the network. One skilled in the art will also recognize that, since the objective function of Equation 5 is not strictly convex, the primal variables cannot be immediately recovered from the dual variables.

However, the present inventors have recognized that it is possible to obtain a fully distributed algorithm by replacing the objective function q by Σₙqₙ and adding the constraints qₙ=qₘ for all n, mεN. Then, each node requires only the Lagrange multipliers of its neighbors, and the need for global coordination is eliminated. To make the objective function strictly convex with respect to qₙ and xₗ, the variables qₙ in the objective are again replaced by qₙ², which as one skilled in the art will recognize does not change the optimal solution. Moreover, one skilled in the art will also recognize that adding a small regularization term εΣₗxₗ² to the objective problem facilitates the recovery of the primal optimal solutions from the dual optimal solutions. The resulting equation is given by:

$${min}_{{x}_{l} \geq 0 , q \geq 0} {\sum }_{n ∈ N} {q}_{n}^{2} + ɛ {\sum }_{l ∈ L} {x}_{l}^{2} \\ subject to \\ {\sum }_{l ∈ O ( n )} {x}_{l} - {\sum }_{l ∈ I ( n )} {x}_{l} = {s}_{n} , n ∈ N \\ {\sum }_{l ∈ O ( n )} {e}_{l} {x}_{l} \leq {q}_{n } {E}_{n} , n ∈ N \\ {\sum }_{l ∈ {C}_{i}} \frac{{x}_{l}}{{c}_{l}} \leq 1 , i = 1 , 2 , … , {N}_{C} \\ {q}_{T ( l )} = {q}_{R ( l )} , l ∈ L \qquad Equation 6$$

where T(l) and R(l) are the transmitting and the receiving nodes of link l, respectively. By applying dual decomposition, a fully distributed algorithm can be obtained, shown in the following update Equations 7-12 at the k-th iteration:

$$\begin{matrix}{q}_{n}^{* ( k )} = \frac{1}{2} {( {v}_{n}^{( k )} {E}_{n} - {\sum }_{l ∈ O ( n )} {κ}_{l}^{( k )} + {\sum }_{l ∈ I ( n )} {κ}_{l}^{( k )} )}^{+} , n ∈ N \\ & Equation 7 \\ {x}_{l}^{* ( k )} = {[ - \frac{1}{2 ɛ} ( {λ}_{T ( l )}^{( k )} - {λ}_{R ( l )}^{( k )} + {v}_{T ( l )}^{( k )} {e}_{l} + \frac{1}{{c}_{l}} {\sum }_{i : l ∈ {C}_{i}} {η}_{i}^{( k )} ) ]}^{+} , l ∈ L \\ & Equation 8 \\ {λ}_{n}^{( k + 1 )} = {λ}_{n}^{( k )} + {{α}_{k} ( {\sum }_{l ∈ O ( n )} {x}_{l}^{* ( k )} + {\sum }_{l ∈ I ( n )} {x}_{l}^{* ( k )} - {s}_{n} )}^{+} , n ∈ N \\ & Equation 9 \\ {v}_{n}^{( k + 1 )} = {[ {v}_{n}^{( k )} + {α}_{k} ( {\sum }_{l ∈ O ( n )} {e}_{l} {x}_{l}^{* ( k )} - {q}_{n}^{* ( k )} {E}_{n} ) ]}^{+} , n ∈ N \\ & Equation 10 \\ {κ}_{l}^{( k + 1 )} = {[ {κ}_{l}^{( k )} + {α}_{k} ( {q}_{T ( l )}^{* ( k )} - {q}_{R ( l )}^{* ( k )} ) ]}^{+} , l ∈ L \\ & Equation 11 \\ {η}_{i}^{( k + 1 )} = {[ {η}_{i}^{( k )} + {α}_{k} ( {\sum }_{l ∈ {C}_{i}} \frac{{{x}_{l}}^{* ( k )}}{{c}_{l}} - 1 ) ]}^{+} , i = 1 , … , {N}_{C} & Equation 12\end{matrix}$$

where (•)+ denotes max {0,•}; qₙ^{*(k)} and xₗ^{*(k)} are the reciprocal of the maximum lifetime and the traffic flow rate through link l, respectively, at iteration k; and λₙ^{(k)}, νₙ^{(k)}, κₗ^{(k)} and ηᵢ^{(k)} are the dual variables (Lagrange multipliers) at iteration k. The update can be started from any initial point and converges to the optimum value with a properly chosen step sizes αₖ>0. For example, the step sizes can be chosen to satisfy αₖ→0 and Σₖαₖ=∞.

These update equations can be viewed as a balancing process analogized to a supply and demand problem. For example, in Equation 12, if the quantity in the parentheses is negative, that means the wireless medium in the i-th contention region is under-utilized, i.e., supply exceeds demand. Thus, the price ηᵢ for the wireless medium is decreased. This, in turn, would lead to an increase of the flow rates across the links in the contention region according to Equation 8. On the other hand, when the quantity in the parentheses in Equation 12 is positive, the price is increased since the demand for the wireless medium exceeds what can be supported. This results in a decrease in the flows across the links in the contention region. Over time, the dual prices converge to the values that can best match supply and demand. One skilled in the art will recognize that such an analogy applies equally to the price for sensor node energy νₙ represented by Equations 7, 8 and 10.

One skilled in the art will recognize in light of the foregoing that the updates represented by Equations 7, 9 and 10 need to be performed at each sensor node; the updates represented by Equations 8 and 11 need to be evaluated on a per-link basis; and the update represented by Equation 12 must be performed for each contention region. For example, to evaluate Equation 7 at sensor node n, the node first needs to collect the dual prices κₗ^{(k)} of all the links connected to sensor node n in either direction. Likewise, to perform the update in Equation 12, a coordinating sensor node in the contention region i must be elected first, and the flow rates xₗ^{*(k)} for all the links in the contention region must be communicated to the coordinating node to do the update.

Therefore, the updates represented by Equations 7-12 are disadvantageous in certain regards. Specifically, before the algorithm is started, each link must explicitly learn the contention regions to which it belongs to perform the update in Equation 8. Also, to perform the update in Equation 12, a local coordinator must be elected in each contention region. While these might not be entirely impossible, they disadvantageously increase the complexity of the MAC protocol. It can also be seen from Equations 8 and 12 that information might need to be exchanged not only between the nodes that have logical connections with each other, but also between those that just interfere with each other. For example, referring once again to FIG. 1, assume that node 110 plays the role of the coordinator for the contention region 310 of FIG. 3. Assuming the updates for each link are done in the transmitters of the corresponding links, in order to perform, for example, the update represented by Equation 8 for link 103, node 130 needs to receive the dual price η₃₀₁^{(k)} from node 110. However, node 110 and node 130 are not directly connected; rather, they only interfere with each other through links 101, 103 and 105. Thus, in order to perform the update of Equation 8, a significant overhead in terms of message flow between those nodes is necessary.

In order to address the foregoing disadvantages, the present inventors have recognized that it is desirable to relax the MAC layer constraints of Equation 1 and to apply a contention penalty term instead to the objective function. The contention penalty term may be generated from the MAC layer when the medium access control procedure is performed by using statistics related to network collisions and any busy medium status. Therefore, the penalty term can be evaluated without any explicit message passing from any one node to another node. Accordingly, the optimization problem in Equation 6 is now revised as:

$${min}_{{q}_{n} \geq 0 , {x}_{l } \geq 0} {\sum }_{n ∈ N} {q}_{n}^{2} + ɛ {\sum }_{l ∈ L} {x}_{l}^{2} + β {\sum }_{i = 1}^{{N}_{C}} {\int }_{0}^{\sum l ∈ {C}_{i} \frac{{x}_{l}}{{c}_{l}}} {π}_{i} ( v ) ⅆ v \\ subject to \\ {\sum }_{l ∈ O ( n )} {x}_{l} - {\sum }_{l ∈ I ( n )} {x}_{l} = {s}_{n} , n ∈ N \\ {\sum }_{l ∈ O ( n )} {e}_{l} {x}_{l} \leq {q}_{n} {E}_{n} , n ∈ N \\ {q}_{T ( l )} = {q}_{R ( l )} , l ∈ L \qquad Equation 13$$

where β is the parameter that represents the severity of the penalty and πᵢ(•) for i=1, 2, . . . , N_{c} are the penalty functions for the i-th contention region. As one skilled in the art will recognize, if the penalty functions are chosen appropriately, the solution to Equation 13 closely approximates the solution to the original formulation of Equation 6. The particular form of the penalty term that ensures that the update equation can be implemented using the collision statistic of the individual links, once again, thus avoiding the high message traffic overhead of centralized control.

One skilled in the art will also recognize that Equation 13 is a convex programming problem. Thus, dual decomposition can be applied to obtain the primal and the dual optimal solutions. The update equations to solve Equation 13, therefore, are given by:

$$\begin{matrix}{q}_{n}^{* ( k )} = \frac{1}{2} {( {v}_{n}^{( k )} {E}_{n} - {\sum }_{l ∈ O ( n )} {κ}_{l}^{( k )} + {\sum }_{l ∈ I ( n )} {κ}_{l}^{( k )} )}^{+} , n ∈ N \\ & Equation 14 \\ {x}^{* ( k )} = {arg min {V}^{( k )}}_{x \geq 0} ( x ) , where {V}^{( k )} ( x ) = V ( x , {λ}^{( k )} , {v}^{( k )} ) \\ & Equation 15 \\ {λ}_{n}^{( k + 1 )} = {λ}_{n}^{( k )} + {{α}_{k} ( {\sum }_{l ∈ O ( n )} {x}_{l}^{* ( k )} + {\sum }_{l ∈ I ( n )} {x}_{l}^{* ( k )} - {s}_{n} )}^{+} , n ∈ N \\ & Equation 16 \\ {v}_{n}^{( k + 1 )} = {[ {v}_{n}^{( k )} + {α}_{k} ( {\sum }_{l ∈ O ( n )} {e}_{l} {x}_{l}^{* ( k )} - {q}_{n}^{* ( k )} {E}_{n} ) ]}^{+} , n ∈ N \\ & Equation 17 \\ {κ}_{l}^{( k + 1 )} = {κ}_{l}^{( k )} + {α}_{k} ( {q}_{T ( l )}^{* ( k )} - {q}_{R ( l )}^{* ( k )} ) , l ∈ L & Equation 18\end{matrix}$$

where V (x, λ, ν) is defined by:

$$V ( x , λ , v ) = β {\sum }_{i = 1}^{{N}_{C}} {\int }_{0}^{\sum {l}^{′} ∈ {C}_{i} \frac{{x}_{l}}{{c}_{l}}} {π}_{i} ( v ) ⅆ v + ɛ {\sum }_{l} {x}_{l}^{2} + {\sum }_{l} ( {λ}_{T ( l )} - {λ}_{R ( l )} + {v}_{T ( l )} {e}_{l} ) {x}_{l} \qquad Equation 19$$

To solve the minimization in Equation 15 at the k-th iteration, the following sub-iteration is performed for each link i:

$$\begin{matrix}{x}_{l}^{( k , {k}^{′} + 1 )} = {( {x}_{l}^{( k , {k}^{′} )} - α \frac{\partial {V}^{( k )} ( {x}^{( k , {k}^{′} )} )}{\partial {x}_{l}} )}^{+} & Equation 20 \\ = {\{ {x}_{l}^{( k , {k}^{′} )} - α [ \begin{matrix}\frac{β}{{c}_{l}} {\sum }_{i \text{:} l ∈ {C}_{i}} {π}_{i} ( {\sum }_{{l}^{′} ∈ {C}_{i}} \frac{{x}_{{l}^{′}}^{( k , {k}^{′} )}}{{c}_{{l}^{′}}} ) + \\ 2 ɛ {x}_{l}^{( k , {k}^{′} )} + {λ}_{T ( l )}^{k} + {λ}_{R ( l )}^{k} + {v}_{T ( l )}^{( k )} {e}_{l}\end{matrix} ] \}}^{+} & Equation 21\end{matrix}$$

which is a gradient descent algorithm with an appropriate step size α>0. Since V^{(k)}(x) is strictly convex, the sequence {xₗ^{(k,k+1)}}, k′=0, 1, . . . , converges to the unique minimizer x*^{(k)}. One skilled in the art will recognize that it is possible to evaluate the penalty term

$${\sum }_{i \text{:} l ∈ {C}_{i}} {π}_{i} ( {\sum }_{{l}^{′} ∈ {C}_{i}} \frac{{x}_{{l}^{′}}^{( k , {k}^{′} )}}{{c}_{{l}^{′}}} )$$

in Equation 21 without the explicit exchange of information among the nodes in one or more contention regions. This is because the ratio xₗ/cₗ represents the fraction of time needed to sustain the flow rate xₗ and it must obey Equations 1, 20 and 22. Therefore, it is possible to derive a MAC scheme where each link i contends for the medium with probability xₗ/cₗ by only considering locally-obtainable values. With such a scheme, as the total time fraction to support the traffic in the contention region i given by

$${\sum }_{{l}^{′} ∈ {C}_{i}} \frac{{x}_{{l}^{′}}}{{c}_{{l}^{′}}}$$

approaches 1, it is more likely to have busy medium status or collision. Mapping

$${π}_{i} ( {\sum }_{{l}^{′} ∈ {C}_{i}} \frac{{x}_{{l}^{′}}}{{c}_{{l}^{′}}} )$$

as the contention probability Pᵢ in the contention region i, one can see that the collision probability that link l experiences is:

$$1 - {\prod }_{i \text{:} l ∈ {C}_{i}} ( 1 - {P}_{i} ) \approx {\sum }_{i \text{:} l ∈ {C}_{i}} {P}_{i} = {\sum }_{i \text{:} l ∈ {C}_{i}} {π}_{i} ( {\sum }_{{l}^{′} ∈ {C}_{i}} \frac{{x}_{{l}^{′}}}{{c}_{{l}^{′}}} ) . \qquad Equation 22$$

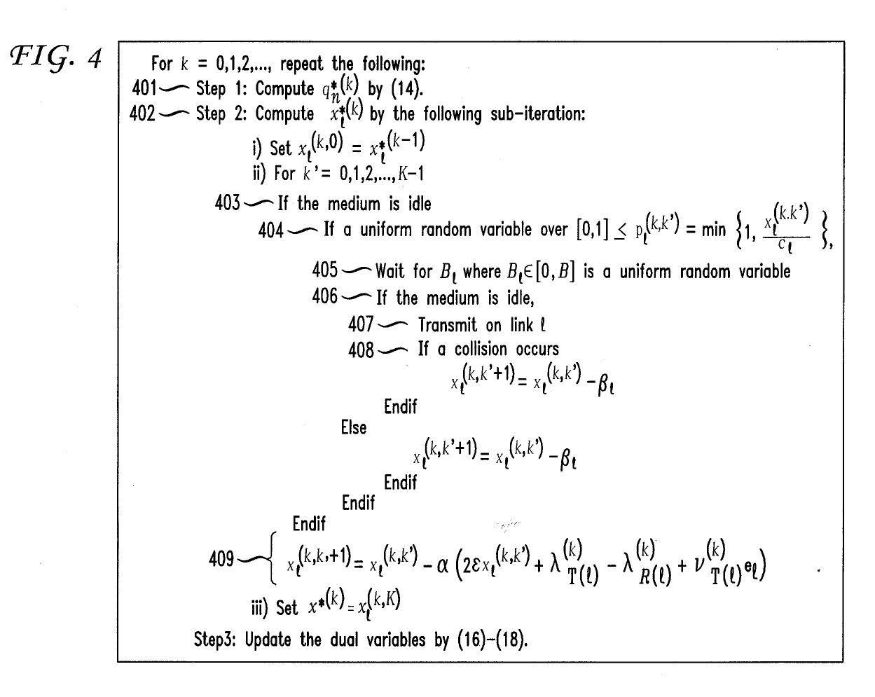

The overall algorithm for joint routing and medium access control is described in pseudo-code in FIG. 4. The algorithm of FIG. 4 advantageously involves information exchange only with the nodes that a node has a logical connection with, and no message passing occurs with the interfering neighbors. Thus, the operation of the network routing algorithm including consideration of the MAC protocol in Equation 21 at iteration k is as follows. First, at step 401 if there is a packet to be transmitted on link l, the transmitting node T(l) senses the medium. As a part of this step, the reciprocal of the maximum lifetime qₙ^{*(k)} computed at node n at iteration k is calculated. At step 402, the traffic flow rate through link lxₗ^{*(k)} for iteration k is calculated. If the medium is idle, at step 403, the network routing algorithm decides to contend for the medium at step 404 with a probability

$${p}_{l}^{( k )} = min \{ 1 , \frac{{x}_{{l}^{′}}^{( k )}}{{c}_{{l}^{′}}} \} ,$$

also referred to herein as a persistence parameter. To participate in the contention, the transmitter first waits at step 405 for a random period of time that is uniformly generated in the interval [0, B] where the window B is common for all the nodes in the network. After that, if the medium becomes busy, or if it is idle but the subsequent transmission experiences a collision at step 408, xₗ^{(k)} is decreased by βₗ, where βₗ=αβ/cₗ. At step 409, in every sub-iteration, xₗ^{(k)} is also decreased by α(2εxₗ^{(k)}+λ_{T(l)}^{(k)}−λ_{R(l)}^{(k)}+ν_{T(l)}^{(k)}eₗ).

Thus, the algorithm can be efficiently implemented, for example, by utilizing the control signals in the actual data packets. One skilled in the art will recognize that the algorithm of FIG. 4 addresses the disadvantages associated with Equations 7-12, discussed above, since the MAC layer constraints are naturally imposed by the medium access procedure and the contention penalty is generated without explicitly identifying the contention regions and without explicit exchange of information between neighboring sensor nodes.

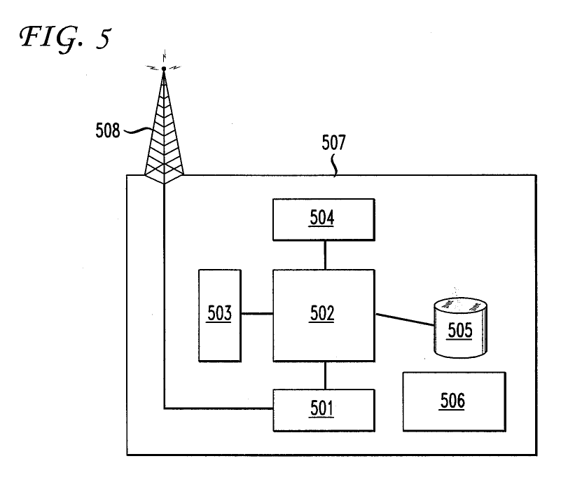

FIG. 5 shows a block diagram of an illustrative sensor node, such as one of nodes 110-160 in FIG. 1, that is adapted to perform calculations associated with the above network routing algorithm, including the aforementioned medium access control calculations. Referring to FIG. 5, network node 507 may be implemented on any suitable computer that is adapted to receive store and transmit data such as the aforementioned network routing and medium access control data. Illustrative sensor node 507 may have, for example, a processor 502 (or multiple processors) which controls the overall operation of the node 507. Such operation is defined by computer program instructions stored in a memory 503 and executed by processor 502. The memory 503 may be any type of computer readable medium, including without limitation electronic, magnetic, or optical media. Further, while one memory unit 503 is shown in FIG. 5, it is to be understood that memory unit 503 could comprise multiple memory units, with such memory units comprising any type of memory. Network node 507 also comprises illustrative network interface 504 for use in programming the network node and/or to facilitate the use of the sensor node 507 in a wired network application. Network node 507 also illustratively comprises a storage medium, such as a computer hard disk drive 505 for storing, for example, data and computer programs adapted for use in accordance with the principles of the present invention as described hereinabove. One skilled in the art will recognize that, due to the typical compact size of sensor nodes that may comprise network node 507, flash memory may preferably be used in place of hard disk drive 505. Network node 507 also illustratively comprises illustrative amplifier 501 and antenna 508 for transmitting the aforementioned calculations in a wireless network. Finally, since many applications of sensor networks that may make up such a network node require an independent power source, network node 507 also has battery 506 to power the above components. One skilled in the art will recognize that network node 507 is merely illustrative in nature and that various hardware and software components may be adapted for equally advantageous use in a computer in accordance with the principles of the present invention.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

What is claimed is:

1. A method for network routing in a distributed sensor network, comprising:
determining whether a transmission medium associated with a first link originating from said sensor node is idle;
if said transmission medium is idle, contending at said sensor node for a transmission slot as a function of a persistence parameter, said persistence parameter a function of a penalty parameter; and
transmitting network traffic in the transmission slot across said first link as a function of said step of contending.

2. The method of claim 1 further comprising the steps of:
associating an energy constraint with a sensor node in the network; and
determining as a function of said energy constraint a first parameter representing an optimal maximum lifetime of said sensor network.

3. The method of claim 1 wherein said persistence parameter is a function of a probability of a collision occurring during a transmission from said sensor node over said link.

4. The method of claim 3 wherein said persistence parameter is a function of xₗ/cₗ, where xₗ is the average flow rate over link l originating from said sensor node, and cₗ is the physical layer flow capacity over link l.

5. The method of claim 3 wherein said persistence parameter is updated upon the occurrence of a collision during a transmission from said sensor node over said link.

6. The method of claim 3 wherein said probability of said collision occurring is represented by the equation
$${\sum }_{i \text{:} l ∈ {C}_{i}} {π}_{i} ( {\sum }_{{l}^{′} ∈ {C}_{i}} \frac{{x}_{{l}^{′}}^{( k , {k}^{′} )}}{{c}_{{l}^{′}}} ) ,$$
where Cᵢ denotes the set of links in the i-th contention region; πᵢ is the penalty function for the i-th contention region; xₗ is average flow rate over link l; and cₗ is the physical layer flow rate capacity of link l.

7. The method of claim 4 wherein said flow rate xₗ is updated upon the occurrence of a collision or a busy medium status according to the equation xₗ^{(k+1)}=xₗ^{(k)}−βₗ, where xₗ^{(k+1)} is the average flow rate over link l at iteration k+1; and βₗ is a penalty parameter for link l.

8. The method of claim 7 wherein said flow rate xₗ is updated as a function of a plurality of Lagrange multipliers.

9. The method of claim 8 wherein said flow rate xₗ is updated according to the equation xₗ^{(k+1)}=xₗ^{(k)}−α(2εxₗ^{(k)}+λ_{T(l)}^{(k)}−λ_{R(l)}^{(k)}+ν_{T(l)}^{(k)}eₗ), where xₗ^{(k)} is the average flow rate over link l at the previous iteration k; λ_{T(l)}^{(k)} and ν_{T(l)}^{(k)} are Lagrange multipliers associated with the transmitting node of link l; λ_{R(l)}^{(k)} is a Lagrange multiplier associated with the receiving node of link l; eₗ is the amount of energy necessary to transmit a unit of network traffic across link l; ε is constant selected such that ε>0; and α is an appropriately selected step size α>0.

10. The method of claim 8 wherein said plurality of Lagrange multipliers represent a solution to a lifetime maximization problem.

11. The method of claim 2 wherein said first parameter representing an optimal maximum lifetime of said sensor node is calculated according to the equation
$${q}_{n}^{* ( k )} = \frac{1}{2} {( {v}_{n}^{( k )} {E}_{n} - {\sum }_{l ∈ O ( n )} {κ}_{l}^{( k )} + {\sum }_{l ∈ I ( n )} {κ}_{l}^{( k )} )}^{+} , \\ n ∈ N$$
where κₗ^{(k)} is a Lagrange multiplier of link l at iteration k; N is the set of sensor nodes n; O(n) is the set of outgoing links from node n; I(n) is the set of incoming links to node i; Eₙ is the energy initially stored at node n; and νₙ is a Lagrange multiplier at iteration k.

12. The method of claim 2 wherein an energy used by a node transmitting over a link is limited as a function of said energy constraint to be less than or equal to the energy available initially at said node.

13. The method of claim 12 wherein said energy constraint is defined as
$${\sum }_{l ∈ O ( n )} {e}_{l} {x}_{l} T \leq {E}_{n} ,$$
where eₗ is the amount of energy necessary to transmit a unit of traffic across link l; xₗ is the average flow rate over link l; T is the lifetime of the network; O(n) is the set of links originating from sensor node n; and Eₙ is the total initial energy available at node n.

14. An apparatus for network routing in a distributed sensor network, comprising:
means for determining whether a transmission medium associated with a first link originating from said sensor node is idle;
means for contending at said sensor node for a transmission slot as a function of a persistence parameter if said transmission medium is idle, said persistence parameter a function of a penalty parameter; and
means for transmitting network traffic in the transmission slot across said first link as a function of said step of contending.

15. The apparatus of claim 14 further comprising:
means for associating an energy constraint with a sensor node in the network; and
means for determining as a function of said energy constraint a first parameter representing an optimal maximum lifetime of said sensor network.

16. The apparatus of claim 14 wherein said persistence parameter is a function of a probability of a collision occurring during a transmission from said sensor node over said link.

17. The apparatus of claim 16 wherein said persistence parameter is a function of xₗ/cₗ, where xₗ is the average flow rate over link l originating from said sensor node, and cₗ is the physical layer flow capacity over link l.

18. The apparatus of claim 16 further comprising means for updating said persistence parameter upon the occurrence of a collision during a transmission from said sensor node over said link.

19. The apparatus of claim 16 wherein said probability of said collision occurring is represented by the equation
$${\sum }_{i \text{:} l ∈ {C}_{i}} {π}_{i} ( {\sum }_{{l}^{′} ∈ {C}_{i}} \frac{{x}_{{l}^{′}}^{( k , {k}^{′} )}}{{c}_{{l}^{′}}} ) ,$$
where Cᵢ denotes the set of links in the i-th contention region; πᵢ is the penalty function for the i-th contention region; xₗ is average flow rate over link l; and cₗ is the physical layer flow rate capacity of link l.

20. The apparatus of claim 17 further comprising means for updating said flow rate xₗ upon the occurrence of a collision or a busy medium status according to the equation xₗ^{(k+1)}=xₗ^{(k)}−βₗ, where xₗ^{(k+1)} is the average flow rate over link l at iteration k+1; and βₗ is a penalty parameter for link l.

21. The apparatus of claim 20 wherein said means for updating updates said flow rate xₗ as a function of a plurality of Lagrange multipliers.

22. The apparatus of claim 21 wherein said means for updating updates said flow rate xₗ according to the equation xₗ^{(k+1)}=xₗ^{(k)}−α(2εxₗ^{(k)}+λ_{T(l)}^{(k)}−λ_{R(l)}^{(k)}+ν_{T(l)}^{(k)}eₗ), where xₗ^{(k)} is the average flow rate over link l at the previous iteration k; λ_{T(l)}^{(k)} and ν_{T(l)}^{(k)} are Lagrange multipliers associated with the transmitting node of link l; λ_{R(l)}^{(k)} is a Lagrange multiplier associated with the receiving node of link l; eₗ is the amount of energy necessary to transmit a unit of network traffic across link l; ε is constant selected such that ε>0; and α is an appropriately selected step size α>0.

23. The apparatus of claim 21 wherein said plurality of Lagrange multipliers represent a solution to a lifetime maximization problem.

24. The apparatus of claim 15 wherein said means for determining determines said first parameter representing an optimal maximum lifetime of said sensor node as a function of the equation
$${q}_{n}^{* ( k )} = \frac{1}{2} {( {v}_{n}^{( k )} {E}_{n} - {\sum }_{l ∈ O ( n )} {κ}_{l}^{( k )} + {\sum }_{l ∈ I ( n )} {κ}_{l}^{( k )} )}^{+} , n ∈ N$$
where κₗ^{(k)} is a Lagrange multiplier of link l at iteration k; N is the set of sensor nodes n; O(n) is the set of outgoing links from node n; I(n) is the set of incoming links to node i; Eₙ is the energy initially stored at node n; and νₙ is a Lagrange multiplier at iteration k.

25. The apparatus of claim 15 wherein an energy used by a node transmitting over a link is limited as a function of said energy constraint to be less than or equal to the energy available initially at said node.

26. The apparatus of claim 25 wherein said energy constraint is defined as
$${\sum }_{l ∈ O ( n )} {e}_{l} {x}_{l} T \leq {E}_{n} ,$$
where eₗ is the amount of energy necessary to transmit a unit of traffic across link l; xₗ is the average flow rate over link l; T is the lifetime of the network; O(n) is the set of links originating from sensor node n; and Eₙ is the total initial energy available at node n.

27. A computer readable medium storing computer program instructions which, when executed on a processor, define the steps of:
determining whether a transmission medium associated with a first link originating from said sensor node is idle;
if said transmission medium is idle, contending at said sensor node for a transmission slot as a function of a persistence parameter, said persistence parameter a function of a penalty parameter; and
transmitting network traffic in the transmission slot across said first link as a function of said step of contending.

28. The computer readable medium of claim 27 further storing computer program instructions which, when executed on a processor, define the steps of:
associating an energy constraint with a sensor node in the network; and
determining as a function of said energy constraint a first parameter representing an optimal maximum lifetime of said sensor network.

29. The computer readable medium of claim 27 wherein said persistence parameter is a function of a probability of a collision occurring during a transmission from said sensor node over said link.

30. The computer readable medium of claim 29 wherein said persistence parameter is a function of xₗ/cₗ, where xₗ is the average flow rate over link l originating from said sensor node, and cₗ is the physical layer flow capacity over link l.

31. The computer readable medium of claim 29 further storing computer program instructions which, when executed on a processor, define the step of:
updating said persistence parameter upon the occurrence of a collision during a transmission from said sensor node over said link.

32. The computer readable medium of claim 29 wherein said probability of said collision occurring is represented by the equation
$${\sum }_{i : l ∈ {C}_{i}} {π}_{i} ( {\sum }_{{l}^{′} ∈ {C}_{i}} \frac{{x}_{{l}^{′}}^{( k , {k}^{′} )}}{{c}_{{l}^{′}}} ) ,$$
where Cᵢ denotes the set of links in the i-th contention region; πᵢ is the penalty function for the i-th contention region; xₗ is average flow rate over link l; and cₗ is the physical layer flow rate capacity of link l.

33. The computer readable medium of claim 30 further storing computer program instructions which, when executed on a processor, define the step of:
updating said flow rate xₗ upon the occurrence of a collision or a busy medium status according to the equation xₗ^{(k+1)}=xₗ^{(k)}−βₗ, where xₗ^{(k+1)} is the average flow rate over link l at iteration k+1; and βₗ is a penalty parameter for link l.

34. The computer readable medium of claim 33 further storing computer program instructions which, when executed on a processor, define the step of:
updating said flow rate as a function of a plurality of Lagrange multipliers.

35. The computer readable medium of claim 34 further storing computer program instructions which, when executed on a processor, define the step of:
updating said flow rate xₗ according to the equation
xₗ^{(k+1)}=xₗ^{(k)}−α(2εxₗ^{(k)}+λ_{T(l)}^{(k)}−λ_{R(l)}^{(k)}+ν_{T(l)}^{(k)}eₗ), where xₗ^{(k)} is the average flow rate over link l at the previous iteration k; λ_{T(l)}^{(k)} and ν_{T(l)}^{(k)} are Lagrange multipliers associated with the transmitting node of link l; λ_{R(l)}^{(k)} is a Lagrange multiplier associated with the receiving node of link l; eₗ is the amount of energy necessary to transmit a unit of network traffic across link l; ε is constant selected such that ε>0; and α is an appropriately selected step size α>0.

36. The computer readable medium of claim 34 wherein said plurality of Lagrange multipliers represent a solution to a lifetime maximization problem.

37. The computer readable medium of claim 28 further storing computer program instructions which, when executed on a processor, define the step of:
calculating said first parameter representing an optimal maximum lifetime of said sensor node according to the equation
$${q}_{n}^{* ( k )} = \frac{1}{2} {( {v}_{n}^{( k )} {E}_{n} - {\sum }_{l ∈ O ( n )} {κ}_{l}^{( k )} + {\sum }_{l ∈ I ( n )} {κ}_{l}^{( k )} )}^{+} , n ∈ N$$
where κₗ^{(k)} is a Lagrange multiplier of link l at iteration k; N is the set of sensor nodes n; O(n) is the set of outgoing links from node n; I(n) is the set of incoming links to node i; Eₙ is the energy initially stored at node n; and νₙ is a Lagrange multiplier at iteration k.

38. The computer readable medium of claim 28 further storing computer program instructions which, when executed on a processor, define the step of:
limiting an energy used by a node transmitting over a link as a function of said energy constraint to be less than or equal to the energy available initially at said node.

39. The computer readable medium of claim 38 wherein said energy constraint is defined as
$${\sum }_{l ∈ O ( n )} {e}_{l} {x}_{l} T \leq {E}_{n} ,$$
where eₗ is the amount of energy necessary to transmit a unit of traffic across link l; xₗ is the average flow rate over link l; T is the lifetime of the network; O(n) is the set of links originating from sensor node n; and Eₙ is the total initial energy available at node n.
